(19) United States
(12) Patent Application Publication
(10) Pub. No.: US 2013/0038565 A1
(43) Pub. Date: Feb. 14, 2013

(54) TOUCH SENSING INTEGRATED WITH DISPLAY DATA UPDATES

(71) Applicants: Donald J. Elloway, San Jose, CA (US); Mark M. Mignard, San Jose, CA (US); William J. Cummings, Hsinchu (TW); Russel A. Martin, San Jose, CA (US)

(72) Inventors: Donald J. Elloway, San Jose, CA (US); Mark M. Mignard, San Jose, CA (US); William J. Cummings, Hsinchu (TW); Russel A. Martin, San Jose, CA (US)

(73) Assignee: QUALCOMM MEMS Technologies, Inc., San Diego, CA (US)

(21) Appl. No.: 13/207,024

(22) Filed: Aug. 10, 2011

(51) Int. Cl. G06F 3/045; G06F 3/041

(52) U.S. Cl. 345/174; 345/173

(57) ABSTRACT

This disclosure provides systems, methods and apparatus for touch sensing on a display device. In one aspect, a method is provided for reducing electrical interference on a display including bi-stable display elements and touch sensing elements without a grounded shielding layer between display elements and touch sensing elements. The method may include placing at least a portion of an array of bi-stable display elements in a selected state with display driver circuitry, maintaining the display elements in the selected state, and obtaining a signal from a touch-sensing element using touch sensing driver circuitry different from the display driver circuitry when the display elements remain in the selected state.

### TECHNICAL FIELD

This disclosure relates to electromechanical systems and related display devices capable of position touch sensing.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure provides an implementation of a method for reducing electrical interference on a display. The display includes bi-stable display elements and touch-sensing elements without a grounded shielding layer between display elements and touch sensing elements. The method includes placing at least a portion of an array of display elements in a selected state with display driver circuitry. The method further includes maintaining the display elements in the selected state. The method further includes obtaining a signal from a touch-sensing element using touch sensing driver circuitry different from the display driver circuitry substantially only during application of the constant hold voltage. The display elements may form a row and column array of interferometric modulators. The interferometric modulators can be placed in a selected state by applying an address voltage to a common line of the array. A hold voltage can be applied along the common line. A signal may be obtained from a touch-sensing element by sensing capacitance.

Another aspect of the disclosure provides an implementation of a display apparatus with touch-sensing capability. The display apparatus includes an array of display elements. The display apparatus further includes an array of touch-sensing elements. The touch-sensing elements are formed over the display elements without being separated by a grounded shield layer. The display apparatus further includes a touch-sensing driver circuit configured to detect input from the touch-sensing elements. The display apparatus further includes a display driving circuit configured to place the display elements in a selected state. The display driving circuit is configured thereafter to maintain the display elements in the selected state. The display apparatus further includes a power source and a processor. The processor is configured to write image data to the display driver circuit. The processor is further configured to obtain touch-sensing input from the touch-sensing driver circuit substantially only when the display elements are maintained in the selected state. The display elements may form a row and column array of interferometric modulators. The interferometric modulators can be placed in a selected state by applying an address voltage to a common line of the array. A hold voltage can be applied the common line. The touch-sensing circuit can be configured to obtain a signal from a touch-sensing element by sensing capacitance of a touch sensing element.

Yet another aspect of the disclosure provides an implementation of a display apparatus with touch-sensing capability. The display apparatus includes display elements and touch-sensing elements without a grounded shielding layer between the display elements and the touch-sensing elements. The display apparatus includes means for placing at least a portion of an array of display elements in a selected state. The display apparatus further includes means for maintaining the display elements in the selected state. The display apparatus further includes means for obtaining a signal from a touch-sensing element substantially only when the display elements are maintained in the selected state.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a typical configuration for a display with a touch sensing layer.

FIG. 10A shows an example of a cross-section of an interferometric modulator display layer with a touch sensing layer according to the general configuration of FIG. 9.

FIG. 10B shows an example of a cross-section of an alternate implementation of an interferometric modulator display layer and a touch sensing layer.

FIG. 11 shows an example of a flow diagram illustrating a method for sensing touch on an interferometric modulator display.

FIG. 12 shows an example of a flow diagram illustrating another method for sensing touch on an interferometric modulator display.

FIG. 13 shows an example of a system block diagram illustrating an electronic device incorporating a 3×3 interferometric modulator display and a touch sensing layer.

FIGS. 14A and 14B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

In some implementations, a display device as described below may incorporate touch sensing capabilities. Unwanted interference between a touch sensing layer and a display layer often requires the inclusion of additional layers to shield the touch sensors from the display. Additional layers may disadvantageously impact the performance of reflective display devices. As an alternative solution, the touch sensing layer may “sense” only when the display is not being updated. For some display element types, a bi-stable display element being one example, a display driver circuit may place elements in a selected state and maintain the elements in the selected state by an application of a constant hold voltage. Touch sensing driver circuitry may perform sensing when the display is in the selected state, between image updates. Some implementations of the method and system disclosed herein may therefore remove the need for additional layers without sacrificing display or touch-sensing performance. For example, some implementations of an interferometric modulator (IMOD) type display described below can incorporate a touch-panel without degradation of the touch-sensor's accuracy or the IMOD's brightness or color fidelity.

One example of a suitable MEMS device, to which the described implementations may apply, is a reflective display device. Reflective display devices can incorporate IMODs to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

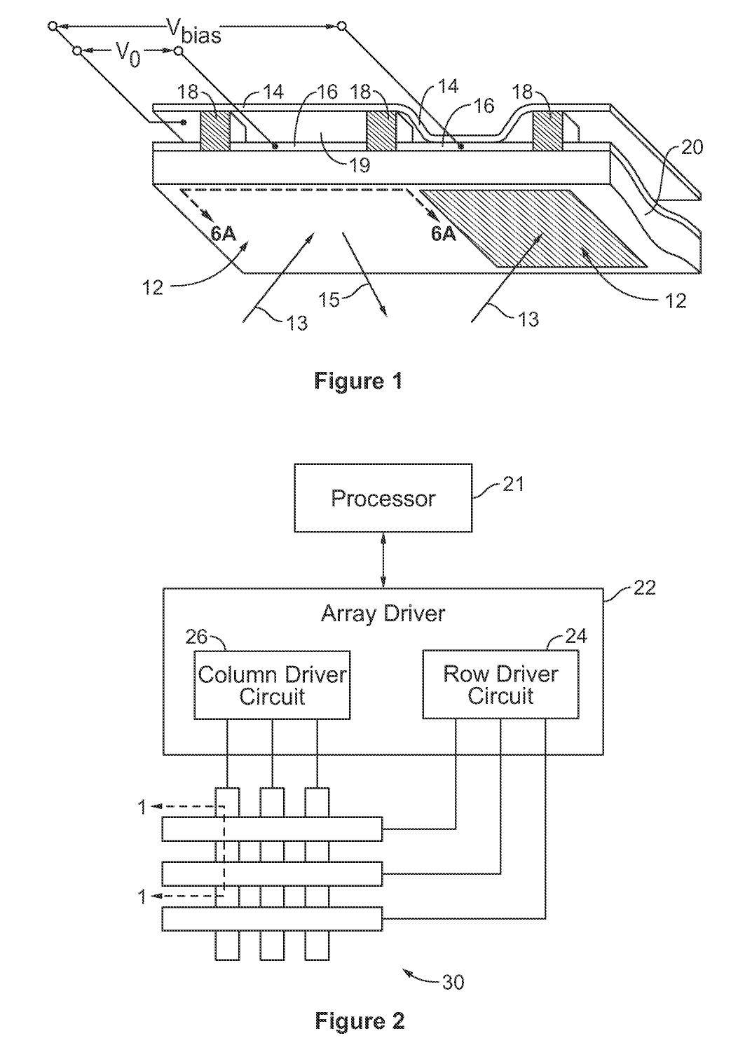

FIG. 1 shows an example of an isometric view depicting two adjacent pixels in a series of pixels of an IMOD display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than about 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

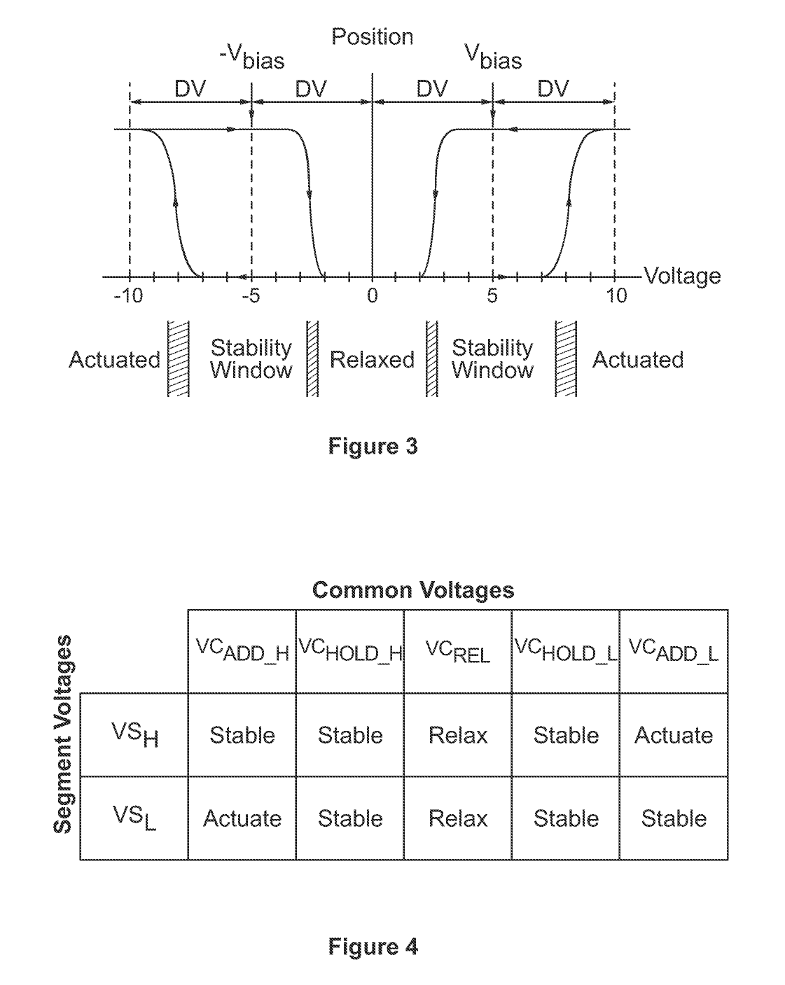

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

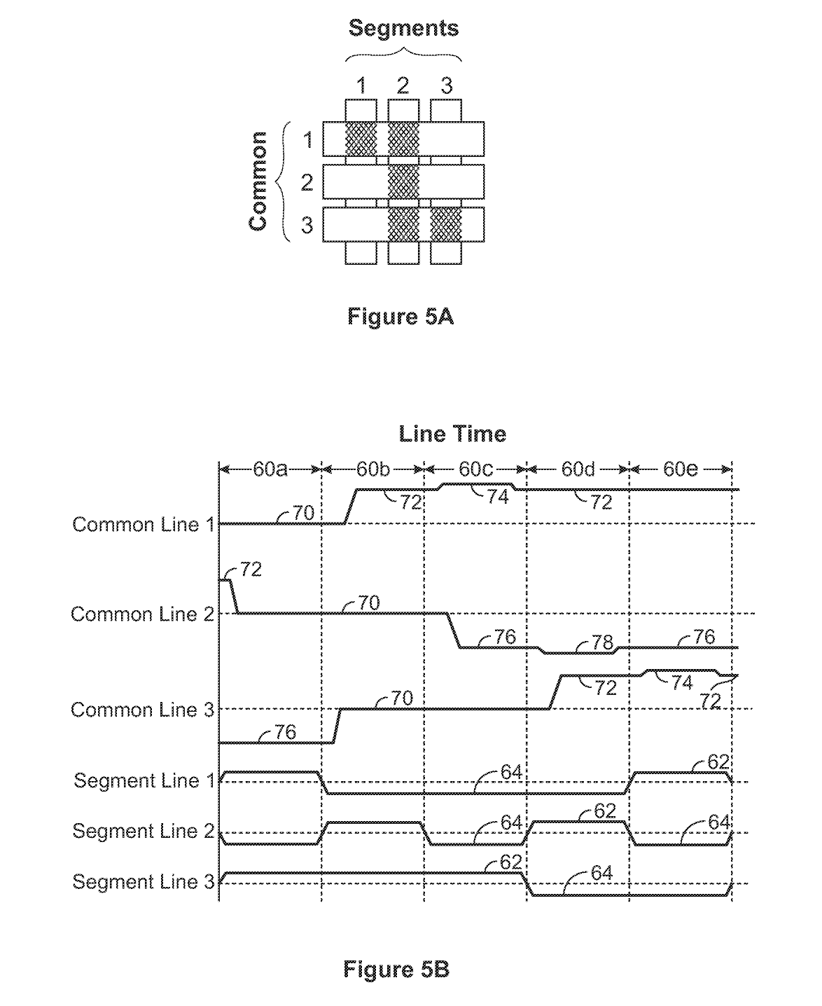

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage V_{VCADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

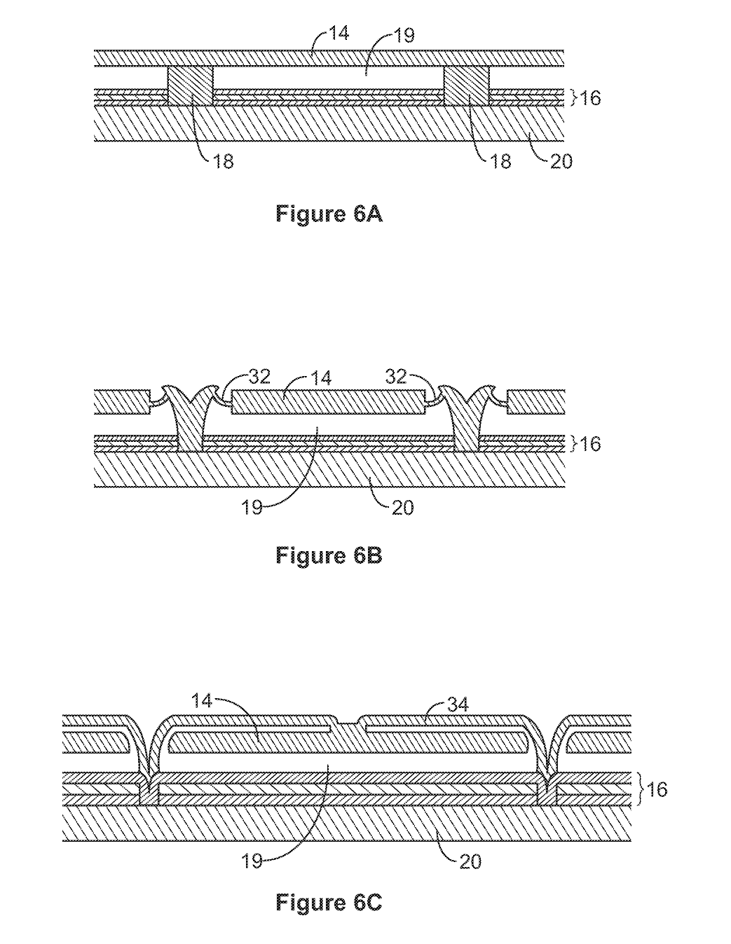

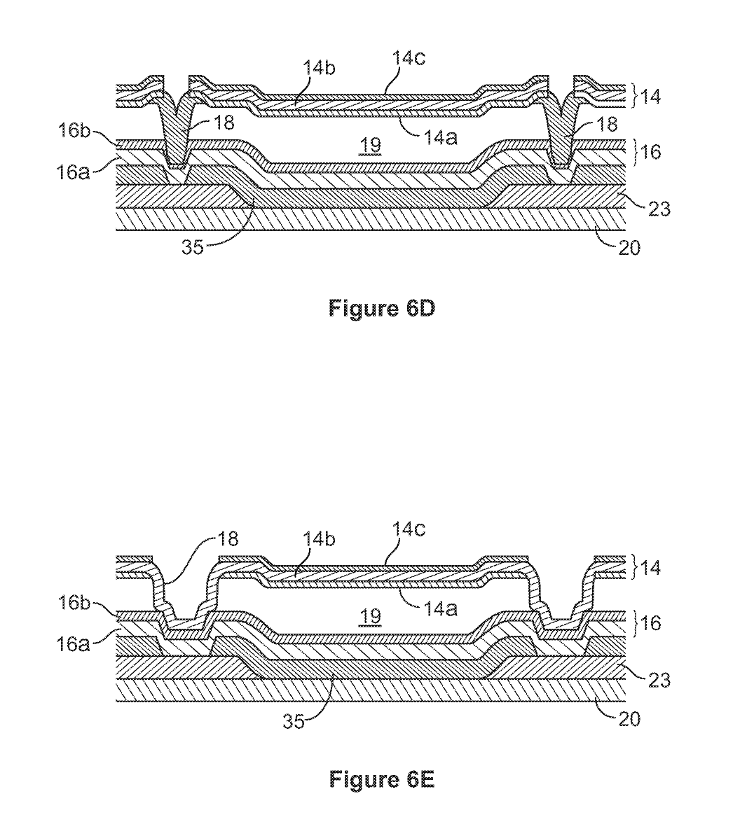

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (CF₄) and/or oxygen (O₂) for the MoCr and SiO₂ layers and chlorine (Cl₂) and/or boron tricholoride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

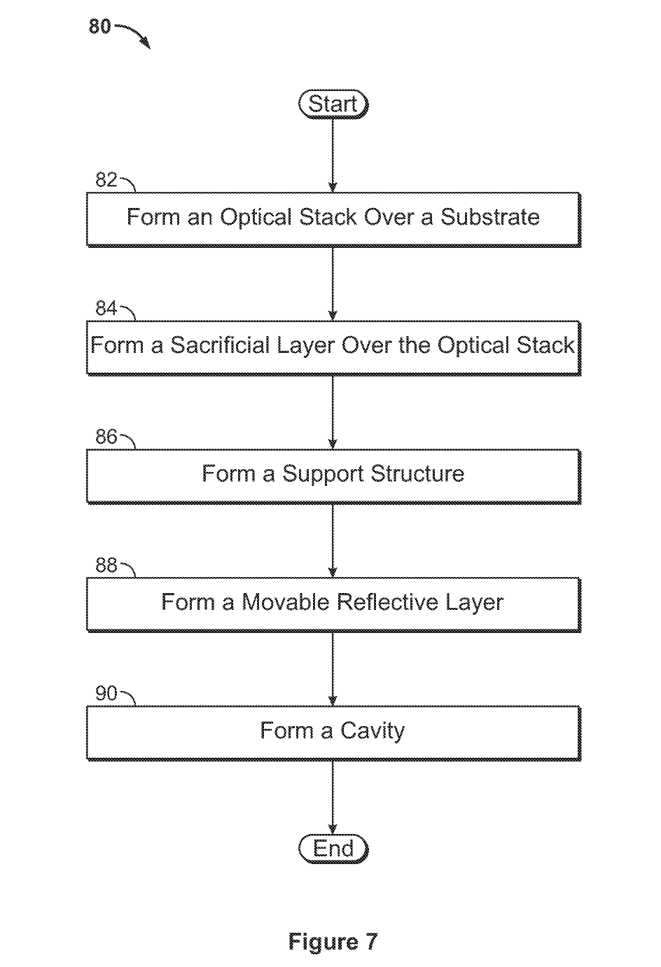

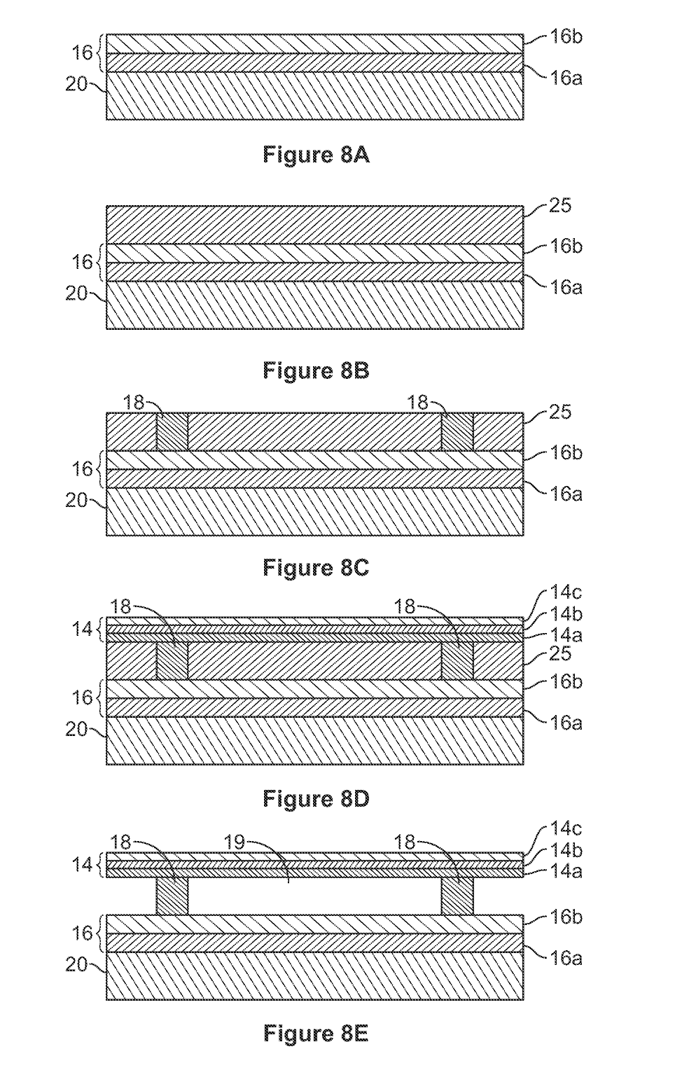

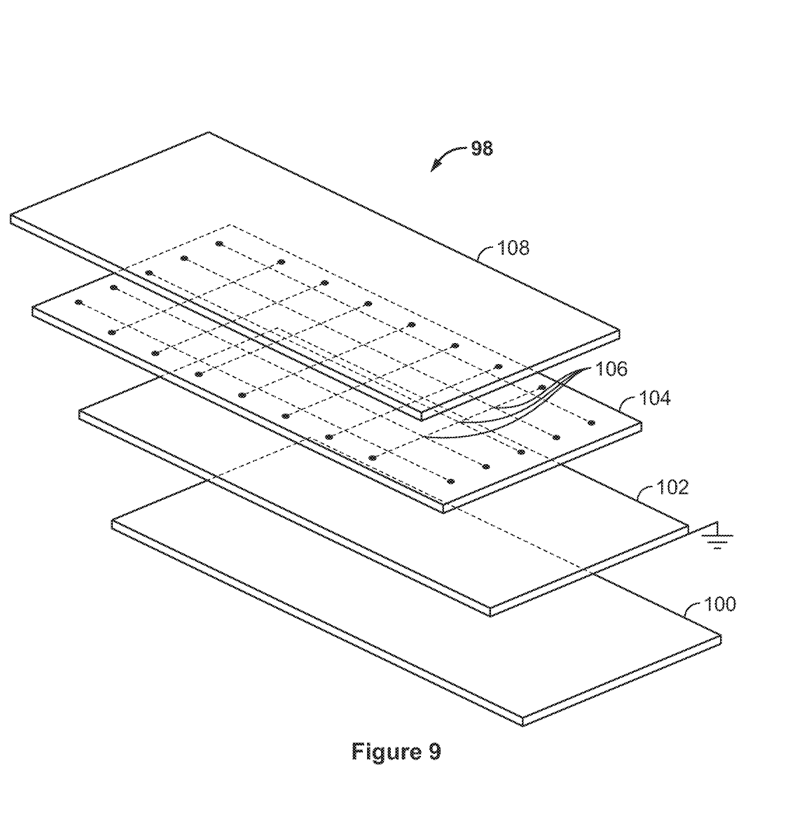

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si ma y be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

An IMOD display array, according to the principles set forth above, may additionally include touch position sensing components to enable graphical interactive selection of features in a screen display application. Several different approaches may be employed to implement touch position sensing. One such approach is based on capacitive sensing. A capacitive touchscreen typically includes an insulator such as glass which is coated or patterned with a transparent conductor such as indium tin oxide (ITO) to form transparent touch sensors. By using two layers of orthogonal traces, capacitance may be sensed at the points where the layers intersect. The capacitance at the intersection will change when another conductor, such as a finger, comes into close proximity to the trace intersection. This change in capacitance can be measured and used to develop touch location data.

In many displays which include touch position tensing, capacitive touch sensors are often located in close proximity to the display elements. As a result, the capacitance at each trace intersection may be inadvertently affected by signals being sent to control the operation of the display elements. For example, changes in voltage sent along data lines to operate an IMOD display element can affect the capacitance of the touch-sensing layer resulting in erroneous touch location data. Therefore, it is generally necessary to include additional layers to separate the electrical operation of the display layer and touch-sensing layer. Adding additional layers may disadvantageously impact the performance of a reflective display element such as an IMOD device as light may be partially absorbed or disturbed by additional layers.

FIG. 9 shows a typical configuration for a display with a touch sensing layer. The display device 98 may include a display layer 100, a grounded shield layer 102, a touch sensing layer 104, and a transparent cover 108. In one implementation, the touch sensing layer 104 may be a capacitive touch-screen which typically includes an insulator such as glass, coated or patterned with a transparent conductor such as indium tin oxide (ITO) to form transparent touch sensors 106. A conductor brought into close proximity of the touch-screen, such as human finger, results in a change in capacitance at the sensor, which can be measured and used to determine the location of a touch. When a touch sensing panel 104 is further integrated with a display layer 100, voltages applied in order to update images on the display layer 100 may interfere with the capacitance sensing signals resulting in erroneous touch location data because the display layer is in close proximity to the touch sensing panel. In some implementations, this distance is less than 3 millimeters, with the interference increasing with closer distances. In order to reduce unwanted interference between the display layer 100 and the touch sensing layer 104, a grounded shield layer 102, such as an ITO shield layer, may be placed between the touch sensing layer 104 and the display layer 100.

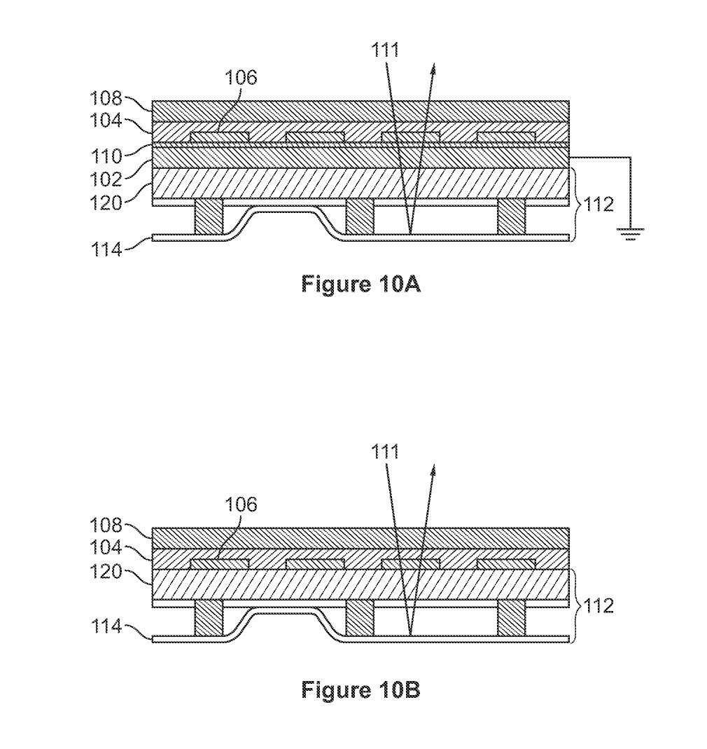

FIG. 10A shows an example of a cross-section of an interferometric modulator display layer with a touch sensing layer according to the general configuration of FIG. 9. FIG. 10A depicts an interferometric modulator display layer 112 with two interferometric modulators (IMODs). As is also illustrated in FIG. 1, the display layer 112 includes a flexible reflective layer 114 and a transparent layer 120, forming bi-stable display elements in this implementation. A touch sensing layer 104 with embedded touch sensors 106 is included above the IMOD display layer along with an insulation layer 110 and a transparent cover layer 108. In accordance with the principles set forth above, the introduction of certain applied voltages across the IMOD display layer 112 will drive the IMODs to change states, such as, for example, into an actuated or unactuated position. To prevent these voltages from interfering with the sensing signals for the touch sensing elements 106, a grounded ITO shield layer 102 is placed between the IMOD display layer 112 and touch sensing layer 104.

The configuration in FIG. 10A may significantly impact the IMOD display performance. As shown in FIG. 10A, ambient light 111 travels through each of the touch sensing layer 104 and grounded shield layer 102 twice. These layers may reflect or absorb ambient light 111 entering into and reflected off the layers of the IMOD element. Because the viewing state of each IMOD display element depends on its reflective properties, the absorbed light may significantly impact display performance. Furthermore, transparent conductors do not necessarily absorb all wavelengths of light in equal proportion, which may give the display undesired tint. For example, ITO absorbs proportionally more blue light, tending to give screens with ITO layers a reddish tint. Thus, FIG. 10A represents an undesirable configuration which may disadvantageously impact IMOD display performance.

FIG. 10B shows an example of a cross-section of an alternate implementation of an interferometric modulator display layer and a touch sensing layer. FIG. 10B shows a touch sensing layer 104 above an IMOD display layer 112, without the use of a grounded shield layer. As is also illustrated in FIG. 1, the display layer 112 includes a flexible reflective layer 114 and a transparent layer 120, forming bi-stable display elements in this implementation. In this configuration, ambient light 111 may travel through only one touch sensing layer 104. In this configuration, disadvantageous reflection and absorption by the ITO layers is reduced.

To reduce interference between the IMOD display layer 112 and the touch sensing layer 104 as depicted in FIG. 10B, a touch-sensor may be selectively “sensed” only, or substantially only, when the display is not being updated. For an IMOD display, after an IMOD is placed in a selected state (i.e., new image data has been written to the IMOD elements), display driver circuits may apply a constant hold voltage on a common line, such as a high hold voltage VC_{HOLD}_{_{—}}_{H} or a low hold voltage VC_{HOLD}_{_{—}}_{L} as noted above. As the applied voltage potential remains substantially fixed, the state of the interferometric modulator may remain stable, and the display driver circuits may produce little or no current. Accordingly, touch-sensors may not experience any electromagnetic interference as the applied hold voltage remains fixed in-between image updates. By avoiding overlap of sensing and updating the IMOD display, each operation may function without interfering with the other. Applying a constant hold voltage is one way of maintaining the display in a selected state for some implementations of the IMOD display devices described specifically herein, but this is not the only application of this technique. One of ordinary skill in the art would appreciate that the technique disclosed herein can be applied to various types of displays in addition to IMOD displays. For instance, any display technology that can be placed in a selected state where the image does not degrade significantly when the image is not being updated or refreshed for a period of time and when display driver voltage and current changes are relatively small compared to the touch sensing electronics can benefit from the technique disclosed herein.

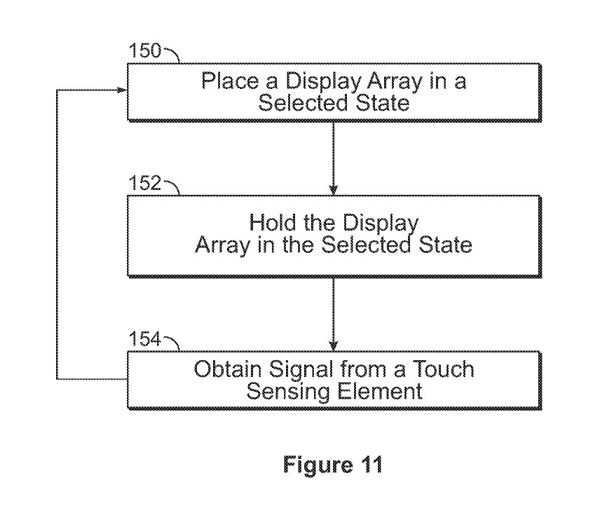

FIG. 11 shows an example of a flow diagram illustrating a method for sensing touch on an interferometric modulator display that can be used with the device as depicted in FIG. 10B, to reduce interference between an IMOD display layer 112 and a touch sensing layer 104. The method may start in block 150 where an IMOD display array is placed in a selected state. In some implementations, the IMOD display array can be placed in a selected state by writing image data to each individual IMOD element according to an image on the display. After image data has been written, the display is held in the selected state in block 152. In one implementation, this may be done by applying a constant hold voltage across each IMOD element to hold the IMOD array in the selected state. The method continues in block 154, where signals are obtained from the touch sensing elements when the display array is held in the selected state. Maintaining the display in the selected state during this period reduces the level of electromagnetic interference from the IMOD display with the signals received from the touch sensors.

After a signal is obtained from a touch sensing element as described in block 154, the signal may be processed to determine touch location data. The display array may not necessarily be held in a selected state while touch-sensor signals are being processed to determine touch location data. The processing of touch-sensor signals to determine touch location data may occur at any time after signals are obtained from touch-sensing elements, and may be performed concurrently with, before, or after placing a display array in a selected state. Thus, the processing of touch-sensor signals to determine touch location data may or may not be performed during the time in which the display array or a display element is maintained in a selected state. Accordingly, processing touch-sensor signals to determine touch location data may be performed in parallel with writing image data to display elements.

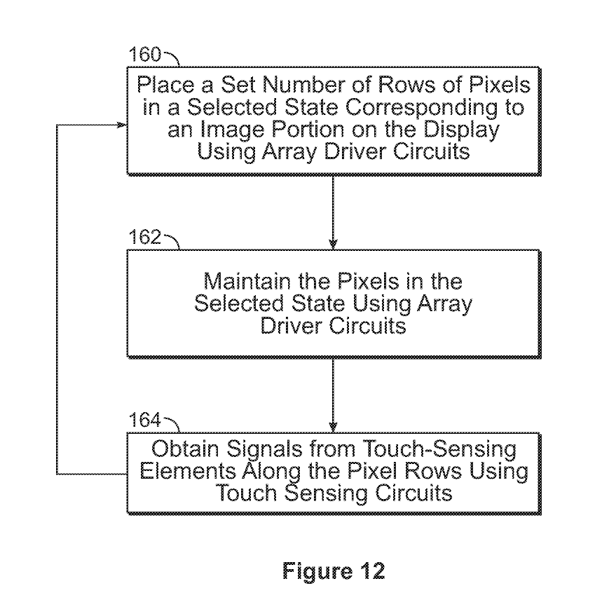

FIG. 12 shows an example of a flow diagram illustrating another method for sensing touch on an interferometric modulator display that can be used with the device as depicted in FIG. 10B to reduce interference between an IMOD display layer 112 and a touch sensing layer 104. The method starts at block 160 when image data is written to a set number of pixel rows such that each pixel along each row is placed in a selected state corresponding to an image portion on a display using array driver circuits. After image data has been written to the rows, the method proceeds to block 162 where the array driver circuits maintain the pixels in the selected state. In one implementation, this may be done by applying a constant hold voltage to each of the previously written rows to maintain the pixels along each row in a selected state. Once the rows are in a selected state, the method proceeds to block 164 where signals are obtained from the touch sensing elements positioned along the pixel rows using touch sensing circuitry. According to this implementation, a number of display lines may be written using display driver circuits, followed by sensing one or more lines of a touch sensing layer using touch sensing driver circuits in an iterative manner.

After signals are obtained from touch sensing elements as described in block 164, the signals may be processed to determine touch location data. As described above, the processing of touch-sensor signals to determine touch location data may occur at anytime after signals are obtained from touch-sensing elements, and may be performed concurrently with, before, or after placing display elements in a selected state. Thus, the processing of touch-sensor signals to determine touch location data may or may not be performed during the time in which the display elements are maintained in a selected state. Accordingly, processing touch-sensor signals to determine touch location data may be performed in parallel with writing image data to display elements.

Additionally, a person having ordinary skill in the art will appreciate that various other methods may accomplish the result as described in FIGS. 11 and 12. In one implementation, a display array driver may hold an entire array of IMOD pixels in a selected state while sensing circuit driver performs touch sensing. In other implementations, a display array driver may hold select sub-arrays or any other defined area of the display in a selected state while a sensing circuit driver performs touch sensing on touch-sensing elements proximate to the sub-array. In other implementations, a display array driver may hold a defined area in a selected state, and a sensing circuit driver may perform touch sensing in the defined area, while the display array driver is updating another area of the display.

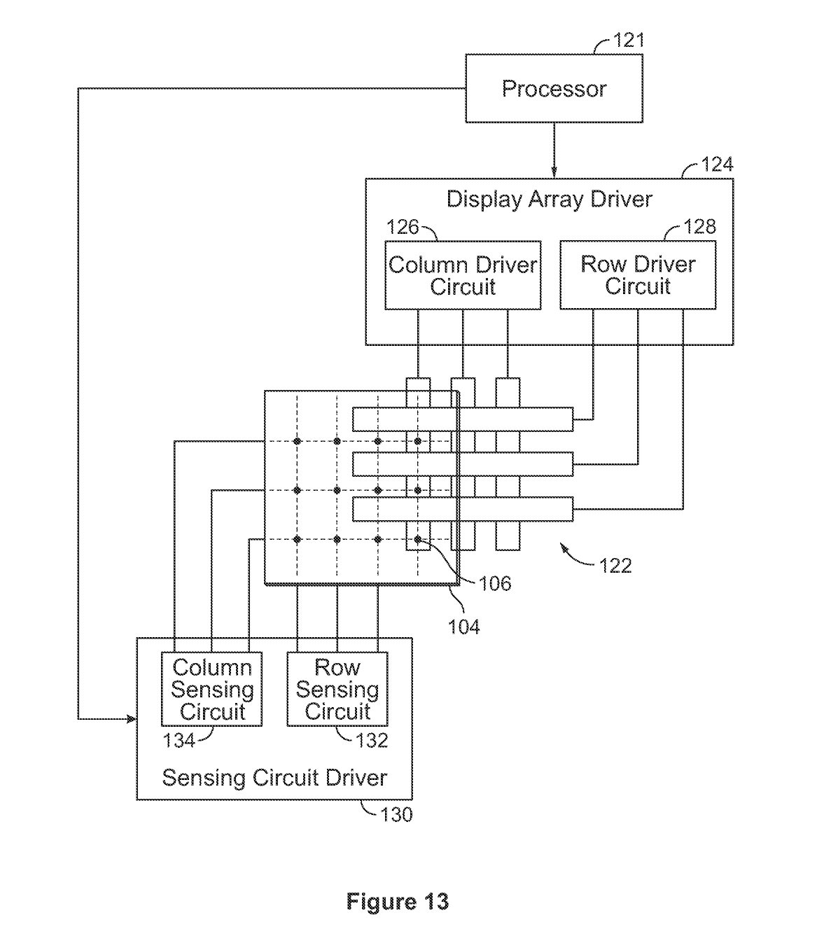

FIG. 13 shows an example of a system block diagram illustrating an electronic device incorporating a 3×3 interferometric modulator display and a touch sensing layer. The electronic device includes a processor 121 that may be configured to execute one or more software modules. The processor 121 can be configured to communicate with a display array driver 124. The display array driver can include a row driver circuit 128 and a column driver circuit 126 that provides signals to, e.g., a display array or panel 122. The display array 122 is illustrated as a 3×3 array of IMODs for the sake of clarity. The display array 122 may contain a different number of IMODs. Further, the number of IMODs in each row and the number of IMODs in each column may or may not be the same in various implementations.

Furthermore, the processor 121 may be configured to communicate with a sensing circuit driver 130. The sensing circuit driver 130 can include a row sensing circuit 132 and a column sensing circuit 134. The sensing circuit driver 130 may have the capability to drive or apply signals to a touch sensing layer 104 with touch sensing elements 106. The touch sensing layer 104 depicted is merely representative of a layer with touch sensing elements 106. A person having ordinary skill in the art will appreciate the various methods and configurations possible for implementing a touch sensing layer 104. For example, in a capacitive sensing layer, two orthogonal rows of conductive traces (e.g., a transparent conductor such as indium tin oxide (ITO)) are arranged in layers in an insulating substrate and over-coated with an insulating and protective surface. The proximity of, for example a finger, to any of the crossing traces causes a change in the sensed capacitance at that location. Alternatively, non-capacitive touch sensing devices may also be implemented, such as resistive touch panel, where pressure deforms an electrode layer of a non-capacitive touch sensing device, causing it to connect to a lower layer and thus, changing a voltage at the contact point. The touch can be detected by measuring the voltage at the contact point.

For a capacitive touch sensing layer, a sensing circuit may be connected to the two layers of the conductive traces embedded into the layer which may measure the capacitance between the two traces where they intersect. In this manner, an effective capacitance can be measured and compared to an expected capacitance to determine whether a region is being touched. Various sensing circuitry and methods may be provided to sense a change in capacitance. In one implementation (not shown), the capacitance may be coupled to an inductive reference element L and a feedback amplifier circuit to function as an oscillator, which operates at the L-C resonance frequency determined by the effective capacitance associated with the intersection of two traces. A measured oscillation frequency that is different from the expected oscillation frequency indicates a touch contact or proximity to contact is evident. The inductor value may be chosen so that the oscillation frequency of the resonant circuit formed is above the frequency range associated with scanning an array of display pixels. This particular implementation is merely one example for measuring capacitance and determining touch and is not intended to be exhaustive.

As depicted in FIG. 13, the processor 121 may communicate with both the display array driver 124 and sensing circuit driver 130 to accomplish the methods described above and depicted in FIGS. 11 and 12. For example, the processor 121 may communicate with the display array driver 124 to write image data to the display. Once image data is written, the display array driver 124 may apply a constant hold voltage across the pixels to hold the pixels in a selected state. The processor 121 may then communicate with the sensing circuit driver to perform sensing while the pixels are in a selected state.

After sensing has been performed, the processor 121 may process touch-sensor signals to determine touch location data. The processor 121 may determine touch location data at anytime after sensing of the touch-sensing elements occurs, which may be concurrently with, before, or after writing image data to the display. Thus, the processing of touch-sensor signals to determine touch location data may or may not be performed during the time in which the pixels are held in a selected state. Accordingly, processing touch-sensor signals to determine touch location data may be performed in parallel with writing image data to display elements.

Thus, the implementations described above may allow, for example, an IMOD-type display to utilize a touch-panel without degradation of the touch-sensor's accuracy or the IMOD's brightness or color fidelity. It should be appreciated that the implementations described may be implemented in a wide variety of display types and touch sensor configurations. For example, the implementations may be incorporated into a wide variety of emissive/transmissive (such as an LCD or CH-LCD display), reflective (such as an electrophoretic or electrowetting display), or transflective displays with touch screen capabilities. For example, with an LCD or elnk display, the methods and implementations described above may be built into the display driver. A person having ordinary skill in the art will appreciate various other configurations for the array drivers and other driver circuits as further noted below.

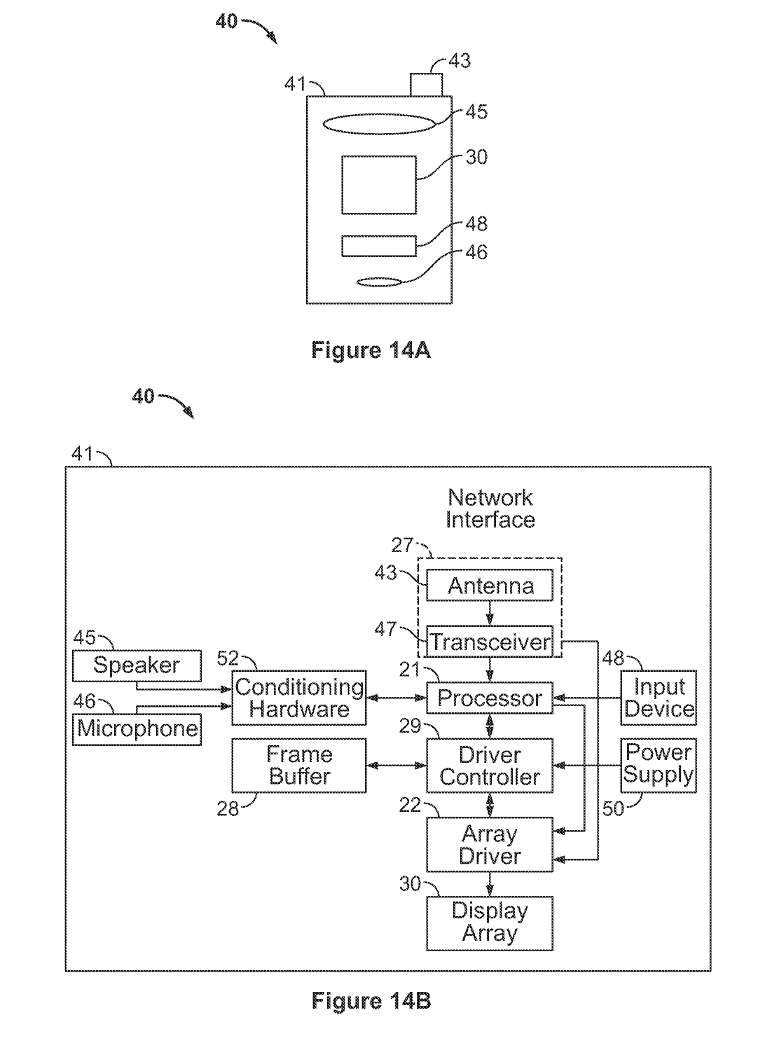

FIGS. 14A and 14B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 14B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for reducing electrical interference on a display, the method comprising:
placing at least a portion of an array of display elements in a selected state with display driver circuitry;
maintaining the display elements in the selected state; and
obtaining a signal from a touch-sensing element using touch sensing driver circuitry different from said display driver circuitry substantially only while the display elements remain in the selected state.

2. The method of claim 1, wherein the selected state is maintained by applying a constant hold voltage to the portion of the array of display elements.

3. The method of claim 1, wherein the touch-sensing element is located in close proximity to the portion of the array of display elements.

4. The method of claim 3, the method further comprising:
placing at least a second portion of the array in a second selected state with the display driver circuitry while obtaining the signal from the touch-sensing element.

5. The method of claim 1, the method further comprising:
placing a different portion of the array in the selected state with the display driver circuitry in parallel with obtaining a signal from the touch sensing element.

6. The method of claim 1, wherein the display elements form a row and column array of interferometric modulators, wherein each interferometric modulator includes:
a movable reflective layer; and
a fixed partially reflective layer positioned at a variable and controlled distance from the movable reflective layer wherein the position of the movable reflective layer determines a pixel viewing state.

7. The method of claim 6, further comprising placing the interferometric modulators in a selected state by applying an address voltage to a common line of the array.

8. The method of claim 7, wherein the common line includes an electrode positioned along a row or column of the array.

9. The method of claim 8, wherein a hold voltage is applied along the common line.

10. The method of claim 1, wherein the touch-sensing elements are arranged in an array.

11. The method of claim 10, further comprising obtaining a signal from a touch-sensing element by sensing capacitance of a touch sensing element.

12. The method of claim 10, wherein a touch sensing element includes a transparent conductor.

13. A display apparatus with touch-sensing capability comprising:
an array of display elements;
an array of touch-sensing elements, wherein the touch-sensing elements are formed over the display elements without being separated by a grounded shield layer;
a touch-sensing driver circuit configured to detect input from at least a portion of the touch-sensing elements;
a display driving circuit configured to place at least a portion of the display elements in a selected state, wherein the display driving circuit is configured thereafter to maintain the portion of the display elements in the selected state; and
a processor configured to
write image data to the display driver circuit; and
obtain touch-sensing input from the at least a portion of touch sensing elements when the portion of the display elements are maintained in the selected state.

14. The display apparatus of claim 13, wherein the portion of touch-sensing elements is located in close proximity to the portion of display elements.

15. The display apparatus of claim 14, wherein the display driving circuit is configured to place at least a second portion of the array of display elements in a second selected state while the processor is obtaining touch-sensing input from the portion of touch sensing elements.

16. The display apparatus of claim 13, wherein the display driving circuit is configured to place a different portion of the array of display elements in the selected state, wherein the placing of the different portion of the array is performed in parallel with obtaining touch-sensing input from the touch-sensing driver circuit.

17. The display apparatus of claim 13, wherein the array of display elements form a row and column array of interferometric modulators, wherein each interferometric modulator includes
a movable reflective layer; and
a fixed partially reflective layer positioned at a variable and controlled distance from the movable reflective layer, wherein the position of the movable reflective layer determines a pixel viewing state.

18. The display apparatus of claim 17, wherein the display driving circuit is configured to place interferometric modulators in the selected state by applying an address voltage to a common line of the array.

19. The display apparatus of claim 18, wherein the common line includes an electrode positioned along a row or column of the array.

20. The display apparatus of claim 19, wherein a hold voltage is applied along the common line.

21. The display apparatus of claim 13, wherein the touch-sensing driver circuit is further configured to obtain a signal from a touch-sensing element by sensing capacitance of the touch sensing element.

22. The display apparatus of claim 13, wherein a touch sensing element includes a transparent conductor.

23. The display apparatus of claim 13, wherein the processor is further configured to process image data and wherein the bi-stable display apparatus further includes:
a memory device that is configured to communicate with the processor

24. The display apparatus as recited in claim 23, further comprising:
a controller configured to send at least a portion of the image data to the display driving circuit.

25. The display apparatus as recited in claim 23, further comprising:
an image source module configured to send the image data to the processor.

26. The display apparatus as recited in claim 25, wherein the image source module includes at least one of a receiver, transceiver, and transmitter.

27. The display apparatus as recited in claim 23, further comprising:
an input device configured to receive input data and to communicate the input data to the processor.

28. The display apparatus as recited in claim 13, wherein the display elements include bistable display elements.

29. The display apparatus as recited in claim 13, wherein there is no grounded shielding layer between the array of display elements and the array of touch sensing elements.

30. A display apparatus with touch-sensing capability comprising:
means for placing at least a portion of an array of display elements in a selected state;
means for maintaining the display elements in the selected state; and
means for obtaining a signal from a touch-sensing element substantially only when the display elements are maintained in the selected state.
